(19) United States
(12) Patent Application Publication
(10) Pub. No.: US 2021/0043179 A1
(43) Pub. Date: Feb. 11, 2021

(54) Longitudinally Divided Pickup Structure and Switching Apparatus

(71) Applicant: S & S Winding LLC, Dalton, GA (US)

(72) Inventor: Scott C. Smith, Dalton, GA (US)

(73) Assignee: S & S Winding LLC, Dalton, GA (US)

(21) Appl. No.: 16/986,783

(22) Filed: Aug. 6, 2020

Related U.S. Application Data
(60) Provisional application No. 62/883,288, filed on Aug. 6, 2019.

(51) Int. Cl. G10H 3/18

(52) U.S. Cl. CPC G10H 3/187; G10H 3/182; G10H 3/181

(57) ABSTRACT

A guitar pickup is provided that is divided into a plurality of segments that can be selectively activated by switching to produce tonal variations.

### BACKGROUND OF THE INVENTION

The present application claims priority to U.S. Provisional Patent Application No. 62/883,288 filed Aug. 6, 2019.

### FIELD OF THE INVENTION

The invention relates generally to variable tone electric guitars and, more particularly, but not by way of limitation, it relates to designs and a switching system for longitudinally dividing and combining pickup outputs to provide a wide variety of output tonalities.

### DESCRIPTION OF THE PRIOR ART

There have been a great number of multi-pickup or multi-coil guitar sound reproduction systems used and/or attempted over the years and many of these types of guitars employ switching between coils or coil combinations. Some of these systems require considerable dexterity and instant recall memory to use in a performance situation. The most efficient of these prior systems have been those that employ a preset where certain tonal choices have already been made for the guitar player. Several of these types employ rotary switches; examples include the Willi Stich systems, and the Paul Reed Smith system, and combining a rotary switch with an active circuit to cooperatively function.

While rotary switches are extremely versatile, they can be tricky to turn correctly when time is of the essence. One reason is that they may be difficult to read or interpret when the guitar is in use on stage. Another common switching system uses an individual on-off switch, usually a small toggle switch, for each of two or three pickups, and coil switching, if necessary, is done by either a fourth toggle switch or by using the three-position switches. In such variations, the center position is “OFF” while a first position is both coils and a third position is a single coil selection. This configuration permits any combination of pickups; however, many of the combinations will require manipulation of two or more switches, often in opposite directions, and this is not an easy movement when it must be executed quickly.

It has long been acknowledged by guitarists and string artists in general that two of the most useful guitar pickup configurations are the GIBSON tonality which incorporates two dual-coil humbucker pickups, and the FENDER tonality, i.e., the system used on the STRATOCASTER, which utilizes three spaced single-coil pickups. A variation employs three pickups but uses a dual-coil pickup in the bridge position to enable a fuller sound when playing lead parts. Yet another variation uses two humbucking pickups adjacent the bridge and fingerboard but inserts a single-coil pickup between them. The GIBSON system uses a three-position switch that allows the artist to select the fingerboard pickup, both pickups, and the bridge pickup. The FENDER system as originally constructed utilized a three-position switch to select either the fingerboard coil, middle coil or the bridge pickup coil alone There were no intentional combinations of pickups available, but such combinations did evolve as the FENDER system was utilized over time.

### SUMMARY OF THE INVENTION

The present invention relates to a more versatile pickup construction that, when combined with appropriate guitar switching systems, provides greater tonal variety than previous pickup and switching systems. The pickup construction divides a single longitudinal row of pole pieces into a plurality of coils that can be selectively activated.

Therefore, it is an object of the present invention to provide a guitar pickup structure and switching system that is versatile in operation and offers selection of a wide variety of tonal qualities.

Other objects and advantages of the invention will be evident from the following detailed description when read in conjunction with the accompanying drawings which illustrate the invention.

### BRIEF DESCRIPTION OF THE DRAWINGS

FIG. 1 is a plan view of an electric guitar in the style of a FENDER STRATOCASTER showing the layout of the electrical pickup units;

FIG. 2 is a diagram of the electrical pickup and switch settings for a FENDER STRATOCASTER;

FIG. 3 is a bottom plan photograph and wiring schematic for a FENDER STRATOCASTER;

FIG. 4A is a perspective view of a divided single coil pickup according to aspects of the invention;

FIG. 4B is a top plan view of the pickup of FIG. 4A;

FIG. 4C is an end plan view of the pickup of FIG. 4A;

FIG. 4D is a left side elevation view of the pickup of FIG. 4A;

FIG. 5A is a perspective view of a single segment of a divided single coil pickup according to aspects of the invention;

FIG. 5B is a top plan view of the pickup segment of FIG. 5A;

FIG. 5C is an end plan view of the pickup of FIG. 5A; and

FIG. 6 is an exploded perspective view of the pickup of FIG. 4A with a housing.

FIG. 7 is a simplified schematic showing the switch wiring for an exemplary selection of preset split pickup segments.

### DETAILED DESCRIPTION OF THE INVENTION

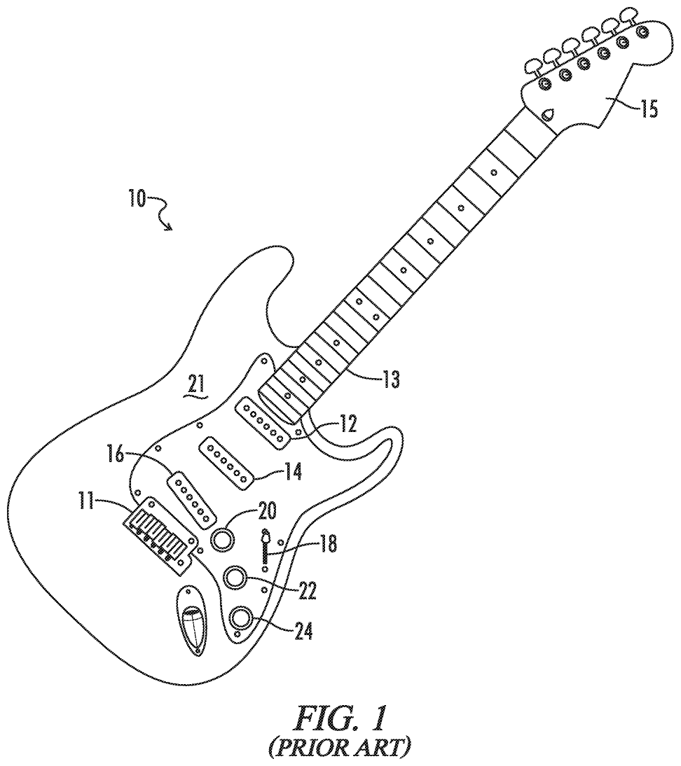

Referring to FIG. 1, a guitar body 10 is shown without guitar strings that would be secured to a bridge 11 and extend up to head 15. Multiple pickups are arrayed on the face 21 of guitar 10 below the paths where strings would be suspended. A single coil pickup 16 is positioned transversely beneath the string paths and closely adjacent the bridge 11, a position known as the “bridge pickup”. In similar manner, a second single coil pickup 12 is secured in spaced relationship closely adjacent the end of fingerboard 13 that extends down the neck of the guitar, and this type of pickup is known as the “fingerboard pickup” or “neck pickup.” A third single coil intermediate pickup 14 is then secured intermediate the position of the bridge and fingerboard pickups 12 and 16 and this can be referred to as the middle pickup. This is representative of the FENDER STRATOCASTER pickup positioning.

The FENDER system originally employed the three spaced single coil pickups and a control switch that could select either fingerboard, middle or bridge pickup by itself. As described below, this switch soon evolved to include certain intended combinations of pickups. The GIBSON system used only the two, spaced dual coil humbucker pickups and allowed switching for selection of the fingerboard/neck pickup, both pickups combined, and the bridge pickup.

Each system has inherent advantages and disadvantages. The GIBSON system is very simple and allows rapid transition from the fingerboard pickup to the bridge pickup, permitting the player to go from chords to lead quickly. A drawback might be its versatility in that only three sounds are easily available. The FENDER system has three combinations of pickup coil that are unavailable on the GIBSON, i.e., fingerboard plus middle coil, middle coil alone, and middle coil plus bridge. However, there is no way to get both fingerboard and bridge pickups together without additional or customized switching.

The single-coil pickups commonly used on FENDER-style guitars have generally lower output but a cleaner sound than GIBSON outputs using the dual humbuckers. There are times when this is useful and times when the player may desire the full GIBSON tonality.

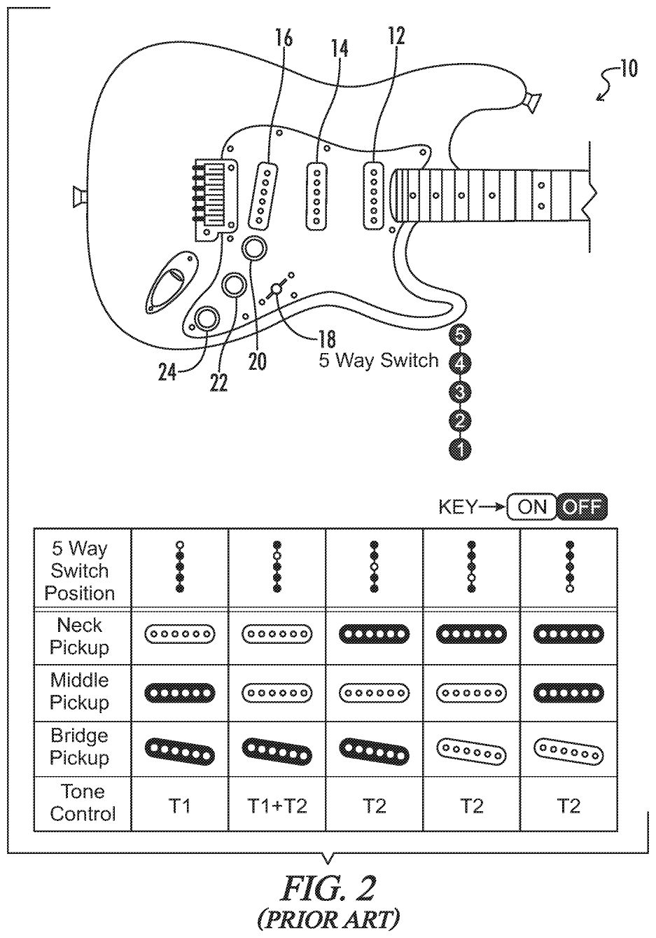

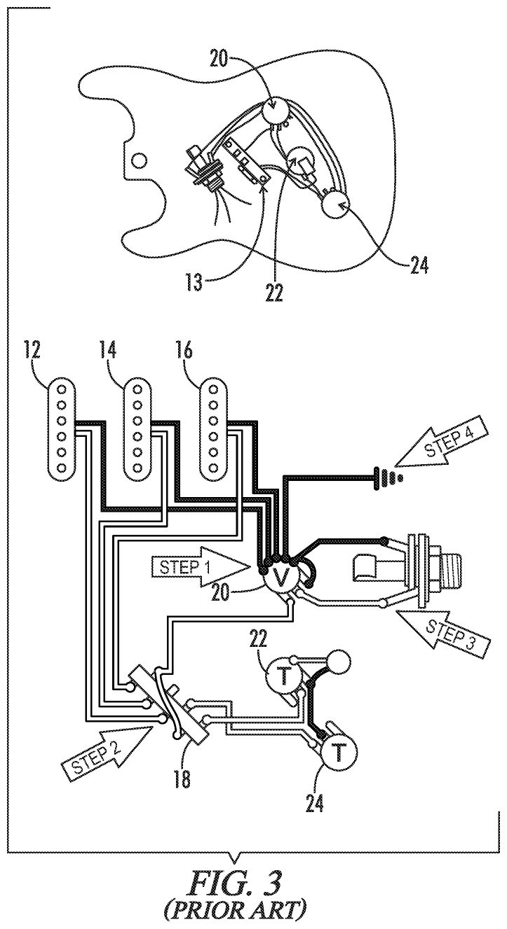

The pickup switch 18 is a key to the FENDER STRATOCASTER'S tonal versatility because it controls which pickups or which combinations of pickups are on at any given time as reflected in the operation of the five-way switch detailed in FIG. 2. The five-position blade-type switch 18 mounted diagonally on the lower half of the pick guard on the face 21 of the guitar can be designated as having positions 1 through 5. As reflected in FIG. 2, this switch affords the following activation of pickups:
Position 1—Neck pickup 12 only
Position 2—Neck pickup 12 and middle pickup 14 together
Position 3—Middle pickup 14 only
Position 4—Middle pickup 14 and bridge pickup 16 together
Position 5—Bridge pickup 16 only.

There is no means of having all three pickups active at once and over time different switching systems have been used with this arrangement of pickups. Until 1977 the pickup selector was a three-position switch and the bridge pickup 16, middle pickup 14, or neck pickup 12 could be turned on individually but no combinations. Guitarists experimented and managed to position the switches in the “in-between” spots to activate the bridge and middle pickup 16,14 or the middle and neck pickup 14,12 and produce different tonality with these dual pickup combinations. The introduction of the five-way switch 18 allowed these combinations to be explicitly selected. The guitar 10 is also provided both with a volume knob 20 and with two tone knobs 22, 24 that can generally be used to reduce higher frequency sounds.

The principal types of pickups used in electric guitars are the single-coil pickups illustrated in FIGS. 1 and 2 and Humbucker pickups. These magnetic guitar pickups work in the same way, they contain magnets (pole pieces) wrapped with coils of wire that react to disturbances caused by the guitar's vibrating metal strings. A modern pickup design for a six-string guitar typically has six poles, each pole corresponding to a string positioned above it. Particularly for bass guitars with fewer strings, there may be four or five pole piece pickups.

Plucking a string causes the pickup to produce a low-powered electronic signal that corresponds to the string's vibrations. The signal is then amplified to a level capable of driving speakers. By producing sound waves, the speaker converts the electronic signal back into mechanical energy, mirroring the strings behavior.

Single coil pickups were first introduced in the 1930s, but as amplification increased, various types of electronic magnetic interference were introduced that was reflected in buzzes and hums in the amplified sound broadcast through speakers. Two techniques were devised to address this electrical interference. In the 1950s, GIBSON introduced the Humbucking pickup, commonly referred to as Humbuckers, which contained two coils that are wired out of phase with each other. This wiring causes the hum generated by each coil to be cancelled out by the other coil but requires additional space on the face of the guitar to accommodate two rows of poles beneath the strings. Single coil pickups were adapted to minimize hum and buzz by winding separate pickups in different directions so that the neck pickup 12 and bridge pickup 16 might be wound in clockwise fashion while the middle pickup 14 would be wound in counterclockwise fashion. In addition, the pole pieces might be oriented with south pole facing upward on the neck 12 and bridge 16 pickups while the north pole might be facing upward in the pole pieces in the middle pickup 14.

The double coil Humbucker type pickups are sometimes split so that one or both rows of six pole pieces can be activated selectively. However, pickups used for tonal selection generally extend across all the strings of a particular guitar.

The strings of an electric guitar are generally identified from bottom to top as:
High E String;
B String;
G String;
D String;
A String; and
Low E String.
   The High E and B strings are solid wire, while the Low E, D and A strings are wound wire. The G string may be solid or wound at the preference of the individual guitarist. The solid or plain string can result in less finger noise and is easier to bend but may not have as full an intonation as an appropriately selected wound string where the winding can alter the tonality.

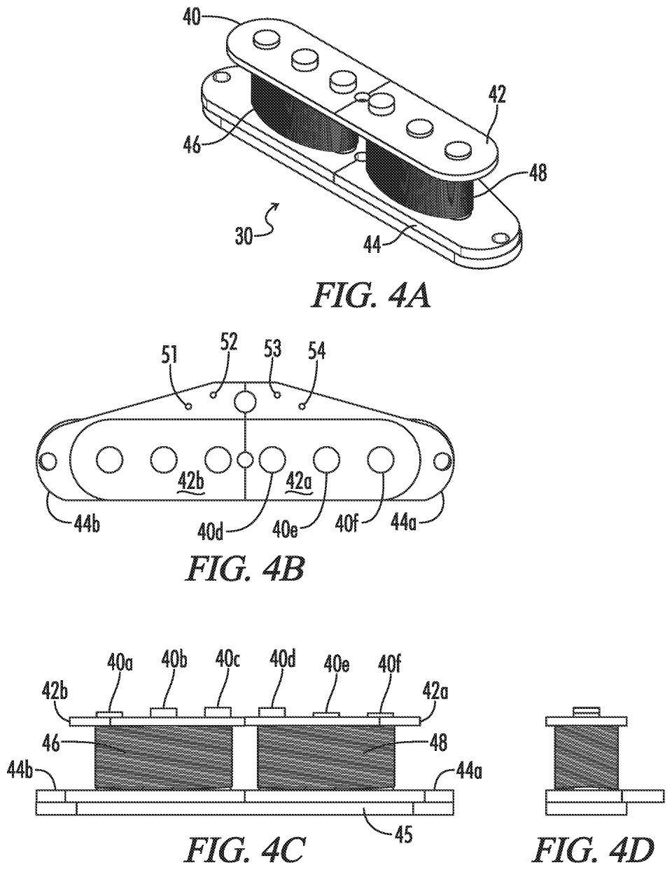

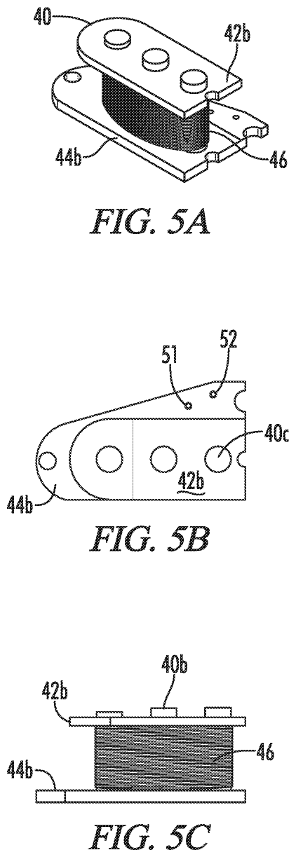

The structure of an example of a longitudinally divided pickup is shown in FIGS. 4-6. The structure generally consists of a bottom flatwork 44 with upstanding pole pieces 40 positioned in openings 47, 49 in the bottom flatwork 44. The flatwork 44 may be used with pole pieces 40 having the same length or, particularly adjacent to the bridge pole pieces, with different lengths such as reflected in FIG. 4C where pole pieces 40b, 40c and 40d have noticeably different overall heights than pole pieces 40a, 40e, 40f. Guitarists may prefer to have different heights and, in some pickup designs the heights of pole pieces and their proximity to strings are adjustable. When the pole pieces are positioned in bottom flatwork 44, the top flatwork 42 can be placed in preparation for winding the coil. When the traditional single coil pickup is made, all six pole pieces 40 are held in unitary top flatwork 42 and unitary bottom flatwork 44.

However, when making a divided longitudinal row of pole pieces, the flatwork must be in separate pieces to facilitate winding so that, as shown in FIG. 4B, top flatwork 42 has part 42a and part 42b, each of which holds three pole pieces received in openings 41, 43 and is associated with bottom flatwork parts 44a and 44b respectively. Once the three pole pieces are positioned passing between the top and bottom flatwork 42,44, the coils are wound. Traditionally 42 or 43 AWG (American Wire Gauge) coil wire is used and coils are wound with as many as 8,000 turns of wire. For the illustrated embodiment, it is preferred to use about 6,000-7,500 turns of wire. Most preferably, it is desired to use about 7000 turns of wire and for the wire to be wound over nearly the entire length of the pole piece, so that there is less than 0.05 inches, and preferably less than about 0.02 inches of unwound pole end.

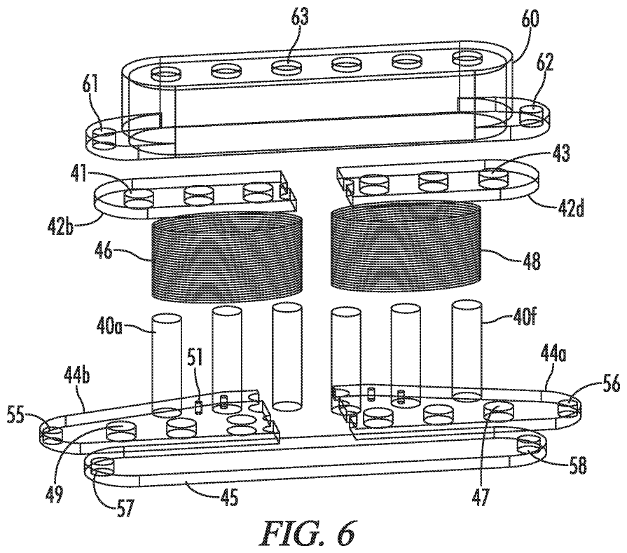

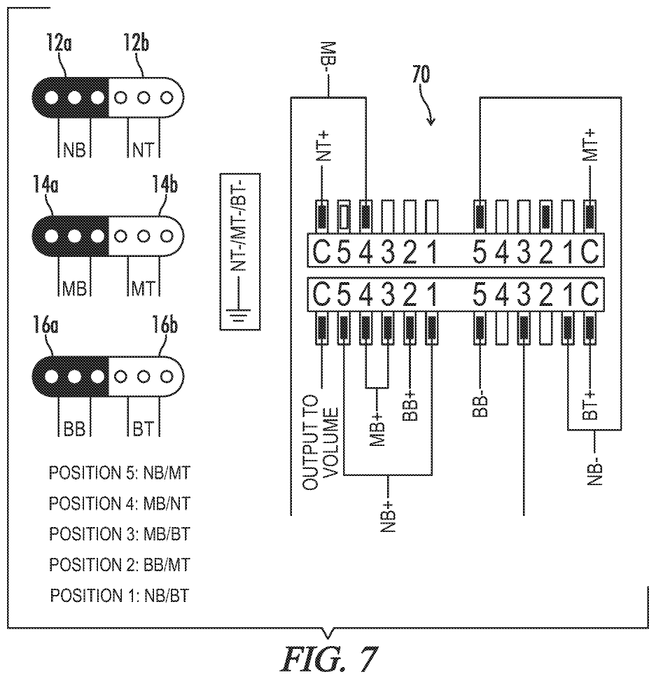

Generally, a lower number of turns produced a brighter sound and a greater number of turns produces a warmer sound. Also, a lower number of turns leads to a lower magnetic field and a lower volume signal being produced. Less than about 7000 turns may lead to some strings generating an inadequate signal. Once wound, the ends of the coiled wire are connected to pickup leads that pass through the openings 51,52 in bottom flatwork 44b and openings 53,54 and bottom flatwork 44a. The leads are then wired to the switching mechanism, one example of which is shown in FIG. 7. The resulting counterclockwise coil 46 on bottom flatwork 44b and clockwise wound coil 48 on bottom flatwork 44a are mounted on a unitary base 45, covered by housing 60 with pole pieces emerging through openings 63 shown in FIG. 6, and secured within the body of guitar 10 so that the pole pieces emerge from the face 21. Screws passing through openings 57, 58 in the base, openings 55, 56 in the bottom flatwork, and openings 61, 62 of the housing can secure the pickup against the back of the face 21 of the guitar 10. Housing 60 preferably is shaped similarly to the original single coil pickup provided with popular electric guitars so that it may be readily installed as a replacement to original equipment or installed by manufacturers as an alternative offering without significant changes to manufacturing practices for the guitars.

It can be seen that the pole pieces in the coils 46, 48 may be magnetized separately to orient the polarity in the same or opposite directions and the pickups may be taped or potted with wax or similar material to protect the windings and help eliminate unwanted feedback.

Although illustrated in connection with a single coil pickup, the same technique can be applied to Humbucker arrangement so that the two rows of a Humbucker are each divided into plurality of segments. In this fashion for instance, the first row of the Humbucker might be divided into two groups of three pole pieces and the second row of the Humbucker divided into two groups of three pole pieces and guitarist could select to activate any one, two, three, or four of the pole piece groups contained within the Humbucker configuration. Similarly, the polarity of each group within the Humbucker assembly can be selected and even a different number of coil windings applied to facilitate the preferred tonal characteristics.

In connection with the split longitudinal pickup coil arrangements, switching becomes potentially complex rather than having two Humbuckers comprising four rows of pole pieces or three single coil pickups, the guitar now contains six or eight, or potentially even more separately addressable pickup assemblies. The number of potential combinations can be limited by wiring design at installation, as is the case with the five-position switch 18 employed on FENDER STRATOCASTER or more complex switching arrangements can be employed. For instance, there exist twenty position rotary switches, or it is also possible to utilize a digital switch that can address any possible combination of pole assemblies.

An exemplary five-position switching arrangement is shown in the schematic of a 5-position, 4-pole switch 70 in FIG. 7. On the left side of the figure, three single coil divided pickups are shown with a dark portion representing the pickups for the D, A, and Low E strings in the neck pickup (NB) 12a, the middle pickup (MB) 14a, and the bridge pickup (BB) 16a. The lighter portion of these pickups correspond to the G, B, and High E strings in the neck pickup (NT) 12b, the middle pickup (MT) 14b, and the bridge pickup (BT) 16b. These divided pickup segments are wired to produce the NB (neck bass string position 12a) and MT (middle treble string position 14b) in switch position 5, MB (middle bass string position 14a) and NT (neck treble string position 12b) in switch position 4, MB (middle bass string position 14a) and BT (bridge treble string position 16b) in switch position 3, MB (bridge bass string position 16a) and MT (middle treble string position 14b) in switch position 2, and NB (neck bass string position 12a) and BT (bridge treble string position 16b) in switch position 1. When using four wound strings and two plain strings, it may prove desirable to dive the longitudinal row of pole pieces into four pieces in the bass side under the wound strings and only two pieces in the treble side under the plain B and High E strings. The desirability of this configuration will vary from player to player, and upon whether they use a relatively low tension wound G string or a relatively high tension wound G string.

Changes may be made in combination and arrangements as heretofore set forth in the specification and shown in the drawings; it being understood that changes may be made in the embodiments disclosed without departing from the spirit and scope of the invention as defined in the following claims.

I claim:

1. A split coil guitar pickup comprising a single row of at least four pole pieces mounted between top flatwork and bottom flatwork wherein a first plurality of pole pieces is wound with at least about 6000 turns of wire in a clockwise direction to form a first coil and a second plurality of adjacent pole pieces is wound with at least about 6000 turns of wire in a counterclockwise direction to form a second coil.

2. The split coil guitar pickup of claim 1 wherein there are six pole pieces in the single row.

3. The split coil guitar pickup of claim 2 wherein each of the first plurality of pole pieces and second plurality of pole pieces comprise three pole pieces.

4. The split coil guitar pickup of claim 1 wherein the top flatwork and the bottom flatwork are comprised of separate flatwork pieces for each of the first and second pluralities of pole pieces.

5. The split coil guitar pickup of claim 1 wherein each of the first and second pluralities of pole pieces is wound with at least about 7,000 turns of wire.

6. The split coil guitar pickup of claim 1 wherein the bottom flatwork of the first and second pluralities of coiled pole pieces is mounted in a unitary base.

7. The split coil guitar pickup of claim 1 wherein the top flatwork of the first and second pluralities of coiled pole pieces is covered by a unitary housing.

8. The split coil guitar pickup of claim 1 wherein the row of at least four pole pieces comprises a row of a humbucker pickup.

9. The split coil guitar pickup of claim 1 wherein pickup leads are connected between the first and second coils and a switching mechanism that allows for the selective activation of the first coil, or the second coil, or both the first and the second coils.

10. A method of manufacturing a split coil guitar pickup comprising the steps of:
arranging a first plurality of three pole pieces in a row between top and bottom flatwork and winding the first plurality of pole pieces with at least 6000 turns of wire in a clockwise direction to form a first coil;
arranging a second plurality of pole pieces in a row between top and bottom flatwork and winding the second plurality of pole pieces with at least 6000 turns of wire in a counter-clockwise direction to form a second coil;
aligning the first and second pluralities of pole pieces to form a single row of pole pieces with separate pickup leads connected to the first coil and to the second coil.

11. The method of claim 10 wherein the first and second pluralities of pole pieces are aligned on a unitary base element;

12. The method of claim 10 wherein the first and second pluralities of pole pieces are covered by a unitary housing member.

13. The method of claim 10 wherein the first and second pluralities of pole pieces are potted with wax.

14. A method of positioning first split coil guitar pickup according to claim 1 proximate a bridge of a guitar so that the first clockwise coil of the first split coil guitar pickup is positioned beneath low strings of the guitar and the second counterclockwise coil of the first split coil guitar pickup is positioned beneath high strings of the guitar and pickup leads from the first clockwise coil and the second counterclockwise coil are connected to a switch that is operable to direct current to neither, both or a selected one of said first and second coils of the first split coil guitar pickup.

15. The method of claim 14 further comprising positioning a second split coil guitar pickup according to claim 1 proximate a neck of said guitar so that the first clockwise coil of the second split coil guitar pickup is positioned beneath high strings of the guitar and the second counterclockwise coil of the second split coil guitar pickup is positioned beneath low strings of the guitar and pickup leads from the first clockwise coil and the second counterclockwise coil are connected to the switch that is operable to direct current to neither, both or a selected one of said first and second coils of the second split coil guitar pickup.

16. The method of claim 15 further comprising the switch being operable to select the first clockwise coil of the first split coil guitar pickup beneath the low strings, together with the first clockwise coil of the second split coil guitar pickup beneath the high strings, and further together with a selected one of the second counterclockwise coils of either the first split coil guitar pickup or the second split coil guitar pickup.

17. The method of claim 15 wherein the switch is configurable to provide for selective activation of at least five different combinations of the first and second coils of the first and second split coil guitar pickups.

18. The method of claim 14 further comprising positioning a second split coil guitar pickup according to claim 1 proximate a neck of said guitar so that the first clockwise coil of the second split coil guitar pickup is positioned beneath low strings of the guitar and the second counterclockwise coil of the second split coil guitar pickup is positioned beneath high strings of the guitar and pickup leads from the first clockwise coil and the second counterclockwise coil are connected to the switch that is operable to direct current to neither, both or a selected one of said first and second coils of the second split coil guitar pickup, and
positioning a third split coil guitar pickup according to claim 1 intermediate the first and second split cold guitar pickups so that the first clockwise coil of the third split coil guitar pickup is positioned beneath high strings of the guitar and the second counterclockwise coil of the third split coil guitar pickup is positioned beneath low strings of the guitar and pickup leads from the first clockwise coil and the second counterclockwise coil are connected to the switch that is operable to direct current to neither, both or a selected one of said first and second coils of the third split coil guitar pickup.

19. The method of claim 18 wherein the switch is configurable to provide for selective activation of at least eight different combinations of the first and second coils of the first, second, and third split coil guitar pickups.

20. The method of claim 18 wherein the switch is digitally programmable with at least twelve different combinations of the first and second coils of the first, second, and third split coil guitar pickups.
